(19) United States
(12) Patent Application Publication
(10) Pub. No.: US 2014/0354651 A1
(43) Pub. Date: Dec. 4, 2014

(54) GRAPHICS DATA PROCESSING APPARATUS AND GRAPHICS DATA PROCESSING SYSTEM

(71) Applicants: Atsushi Hori, Chiyoda-ku (JP); Shinya Taguchi, Chiyoda-ku (JP); Takenori Kawamata, Chiyoda-ku (JP); Daisuke Kisara, Chiyoda-ku (JP); Tomoaki Saito, Chiyoda-ku (JP); Hitoshi Morishita, Chiyoda-ku (JP)

(72) Inventors: Atsushi Hori, Chiyoda-ku (JP); Shinya Taguchi, Chiyoda-ku (JP); Takenori Kawamata, Chiyoda-ku (JP); Daisuke Kisara, Chiyoda-ku (JP); Tomoaki Saito, Chiyoda-ku (JP); Hitoshi Morishita, Chiyoda-ku (JP)

(73) Assignee: Mitsubishi Electric Corporation, Chiyoda-ku, Tokyo (JP)

(21) Appl. No.: 14/371,616

(22) PCT Filed: Jan. 17, 2013
(86) PCT No.: PCT/JP13/50795

§ 371 Date: Jul. 10, 2014

(30) Foreign Application Priority Data
Feb. 20, 2012 (JP) 2012-034011

(51) Int. Cl. G06T 11/20

(52) U.S. Cl. CPC G06T 11/20; G06T 2207/20072
USPC 345/441

(57) ABSTRACT

Besides an input event reception unit 4 that receives an input such as a coordinate input event or the like and accumulates the coordinate input event or the like in an event queue 7, and an event executing device that performs the coordinate input event accumulated in the event queue 7, there are provided a drawing event reception unit 5 that receives a drawing event designating drawing contents on a screen, an update processing unit 14 that updates drawing contents in accordance with the drawing event received by the drawing event reception unit 5, and a drawing processing unit 16 that displays the drawing contents on the screen every time the drawing contents are updated.

### TECHNICAL FIELD

The present invention relates to a graphics data processing apparatus and a graphics data processing system that update drawing contents of a picture in accordance with an event.

### BACKGROUND ART

For example, a graphics data processing apparatus disclosed in the following Patent Document 1 monitors an executing state of a drawing command, and if the executing state thereof exceeds a prescribed degree, it skips notification processing of a hardware event thereafter for a prescribed period of time.

This will make it possible to execute drawing processing efficiently and to draw a picture in real time.

However, since a hardware event that newly occurs during the skip of the notification processing of the hardware event is accumulated in an event queue successively, the processing accumulation of hardware events can sometimes take place.

### PRIOR ART DOCUMENT

### Patent Document

Patent Document 1: Japanese Patent Laid-Open No. 5-35835 (Paragraph [0023], and FIG. 1).

### DISCLOSURE OF THE INVENTION

### Problems to be Solved by the Invention

With the foregoing configuration, although the conventional graphics data processing apparatus monitors the executing state of the drawing command, and even if a drawing event designating the drawing contents of a picture occurs when the executing state exceeds the prescribed degree, it skips the notification processing of the drawing event and accumulates it in the event queue. Accordingly, it has a problem of being unable to update the drawing contents of the picture in real time in accordance with the drawing event.

The present invention is implemented to solve the foregoing problem. Therefore it is an object of the present invention to provide a graphics data processing apparatus and a graphics data processing system capable of updating the drawing contents of a picture in real time and of achieving smooth drawing while suppressing jerks or the like.

### Means for Solving the Problem

A graphics data processing apparatus in accordance with the present invention comprises, in addition to an event input device that receives input of an event and accumulates the event in an event queue; an event acquiring device that acquires an event accumulated in the event queue; and an event executing device that executes the event acquired by the event acquiring device, a drawing event reception device that receives a drawing event designating drawing contents of a screen; a drawing content update device that updates drawing contents in accordance with the drawing event received by the drawing event reception device; and a picture drawing device that displays, every time the drawing contents are updated by the drawing content update device, the drawing contents on the screen.

### Advantages of the Invention

According to the present invention, it is configured in such a manner as to comprise, in addition to an event input device that receives input of an event and accumulates the event in an event queue; an event acquiring device that acquires an event accumulated in the event queue; and an event executing device that executes the event acquired by the event acquiring device, a drawing event reception device that receives a drawing event designating drawing contents of a screen; a drawing content update device that updates drawing contents in accordance with the drawing event received by the drawing event reception device; and a picture drawing device that displays, every time the drawing contents are updated by the drawing content update device, the drawing contents on the screen. Accordingly, it offers an advantage of being able to update the drawing contents of the picture in real time, and to achieve the smooth drawing with jerks and the like being suppressed.

### BRIEF DESCRIPTION OF THE DRAWINGS

FIG. 1 is a block diagram showing a configuration of a graphics data processing apparatus of an embodiment 1 in accordance with the present invention;

FIG. 2 is a diagram illustrating a display example of a graphics data processing apparatus (display example of a needle meter);

FIG. 3 is a diagram illustrating a display example of a graphics data processing apparatus (display example of a bar meter);

FIG. 4 is a block diagram showing a configuration of a graphics data processing apparatus of an embodiment 2 in accordance with the present invention;

FIG. 5 is a block diagram showing a configuration of a graphics data processing apparatus of an embodiment 3 in accordance with the present invention;

FIG. 6 is a diagram illustrating a large screen comprising six display units;

FIG. 7 is a block diagram showing a configuration of a graphics data processing system of an embodiment 4 in accordance with the present invention; and

FIG. 8 is a block diagram showing a configuration of a graphics data processing system of an embodiment 5 in accordance with the present invention.

### BEST MODE FOR CARRYING OUT THE INVENTION

The best mode for carrying out the invention will now be described with reference to the accompanying drawings to explain the present invention in more detail.

### Embodiment 1

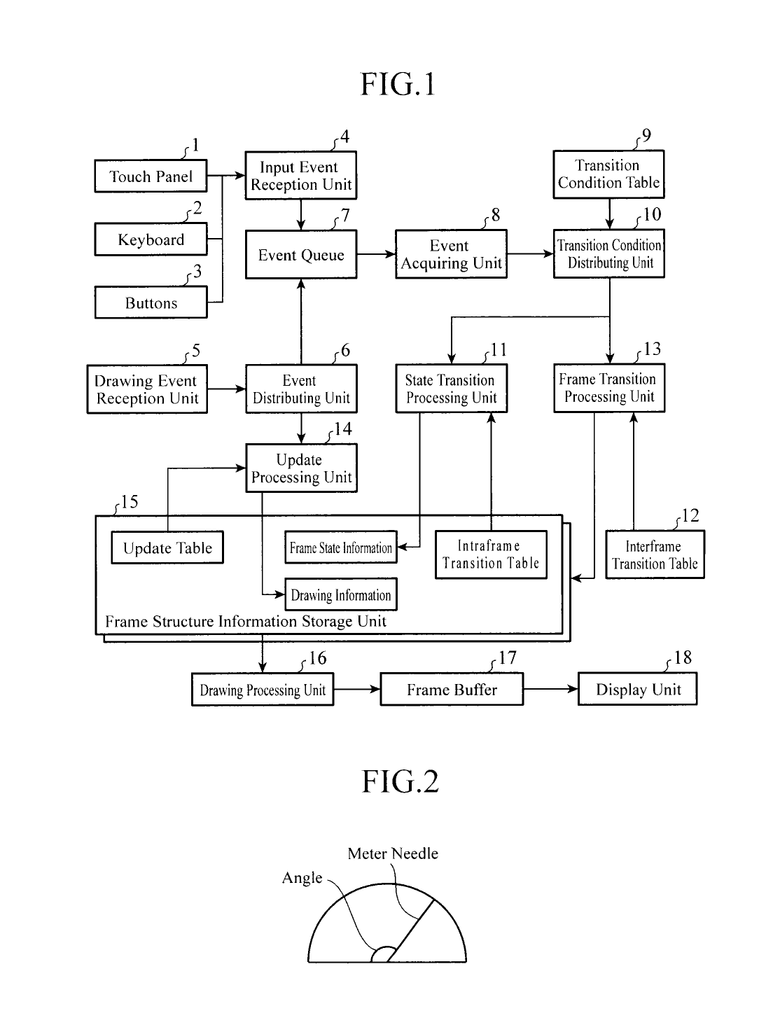

FIG. 1 is a block diagram showing a configuration of a graphics data processing apparatus of an embodiment 1 in accordance with the present invention.

In FIG. 1, a touch panel 1, a keyboard 2 and buttons 3 are a user interface a user can operate to input an event.

The present embodiment 1 supposes, as an event input through the touch panel 1, keyboard 2 or buttons 3, a frame transition event that instructs a transition of a frame, and a coordinate input event that designates coordinates on the screen or the like.

They are only an example, and any events other than the frame transition event and the coordinate input event can also be input.

An input event reception unit 4, which is an interface with the touch panel 1, keyboard 2 and buttons 3, performs the processing of receiving an event input by a user who operates the touch panel 1, keyboard 2 or buttons 3, and of supplying the event to an event queue 7.

Incidentally, the touch panel 1, keyboard 2, buttons 3 and input event reception unit 4 constitute an event input device.

A drawing event reception unit 5 is an interface that receives a drawing event (event that designates drawing contents of a picture) transmitted from an external sensor (a speedometer of a motorcar or a tachometer of an engine) or a computer, for example, or receives a frame transition event, and accepts the drawing event or frame transition event. Incidentally, the drawing event reception unit 5 constitutes a drawing event reception device.

An event distributing unit 6 is comprised of a semiconductor integrated circuit incorporating a CPU, or of a single-chip microcomputer, for example, and executes the processing that supplies, if the event accepted by the drawing event reception unit 5 is a drawing event, the event to an update processing unit 14, and supplies, if the event accepted by the drawing event reception unit 5 is a frame transition event, the event to the event queue 7.

The event queue 7 is a memory that accumulates, when the event is supplied from the input event reception unit 4 or from the event distributing unit 6, the event in order of receipt (or in order of priority of the events).

An event acquiring unit 8 is comprised of a semiconductor integrated circuit incorporating a CPU, or of a single-chip microcomputer, for example, and executes the processing of acquiring an event accumulated in the event queue 7 in turn. Incidentally, the event acquiring unit 8 constitutes an event acquiring device.

A transition condition table 9 is comprised of a memory or the like, for example, and stores transition condition information that is referred to when deciding on whether the event acquired by the event acquiring unit 8 instructs an intraframe transition or an interframe transition.

For example, it stores the coordinates of a region on the touch panel that accepts the intraframe transition, or the coordinates of a region on the touch panel that accepts the interframe transition.

A transition condition distributing unit 10 is comprised of a semiconductor integrated circuit incorporating a CPU or of a single-chip microcomputer. If the event acquired by the event acquiring unit 8 is a frame transition event, the transition condition distributing unit 10 executes the processing of instructing, if the frame transition event is an event relating to the intraframe transition, a state transition processing unit 11 to execute the intraframe transition, and of instructing, if the frame transition event is an event relating to the interframe transition, a frame transition processing unit 13 to execute the interframe transition.

In addition, if the event acquired by the event acquiring unit 8 is a coordinate input event, the transition condition distributing unit 10, referring to the transition condition information stored in the transition condition table 9, executes the processing of deciding on whether the coordinate input event instructs the intraframe transition or the interframe transition, and instructs, if it instructs the intraframe transition, the state transition processing unit 11 to execute the intraframe transition, and instructs, if it instructs the interframe transition, the frame transition processing unit 13 to execute the interframe transition.

The state transition processing unit 11, which is comprised of a semiconductor integrated circuit incorporating a CPU or of a single-chip microcomputer, executes the intraframe transition by altering the currently valid frame state information in a frame structure information storage unit 15 (information designating the frame structure of a drawing picture, which corresponds, for example, to the information designating a state of components to be displayed on a screen (information designating visibility/invisibility)) in accordance with the execution instruction of the intraframe transition output from the transition condition distributing unit 10. It is conceivable as the intraframe transition, for example, the processing of displaying another picture designating a table or graph in a part of the screen.

An interframe transition table 12, which is comprised of a memory, for example, stores the frame structure information storage unit 15 corresponding to each frame.

The frame transition processing unit 13, which is comprised of a semiconductor integrated circuit incorporating a CPU, or of a single-chip microcomputer, receiving the instruction to execute the interframe transition from the transition condition distributing unit 10, specifies the frame structure information storage unit 15 corresponding to the transition destination frame by referring to the interframe transition table 12, enables the frame structure information storage unit 15 and disables the other frame structure information storage units 15, thereby executing the interframe transition.

Incidentally, the transition condition table 9, transition condition distributing unit 10, state transition processing unit 11, interframe transition table 12 and frame transition processing unit 13 constitute an event executing device.

The update processing unit 14, which is comprised of a semiconductor integrated circuit incorporating a CPU or of a single-chip microcomputer, executes the processing of altering the drawing information in the currently valid frame structure information storage unit 15 (information designating the drawing contents of the picture, which corresponds, for example, to the positional information, rotational information, frame number and the like of a component to be displayed on the screen) in accordance with the drawing event output from the event distributing unit 6. Incidentally, the update processing unit 14 constitutes a drawing content update device.

The frame structure information storage unit 15, which is comprised of a memory, for example, is prepared by the number of transition-capable frames (for example, if the number of the transition-capable frames is N, then N frame structure information storage units 15 are prepared).

The N frame structure information storage units 15 store as the frame structure information not only the frame state information and drawing information mentioned above, but also an update table which is information for displaying the components in the picture (when the component to be displayed in the picture is a speedometer of FIG. 2, for example, it corresponds to a comparative table or the like which shows the correspondence of the angle information of a needle of the speedometer to the speed information), and an intraframe transition table showing an intraframe transition state.

Incidentally, among the N frame structure information storage units 15, only the one corresponding to the frame that is being drawn now is enabled, and those corresponding to the frames that are not being drawn now are disabled.

A drawing processing unit 16, which is comprised of a GPU (Graphics Processing Unit), for example, executes, when the state transition processing unit 11 alters the frame state information in the currently valid frame structure information storage unit 15, or when the frame transition processing unit 13 alters the currently valid frame structure information storage unit 15, the processing of drawing a picture on the display unit 18 by writing the data of the picture into the frame buffer 17 with the frame structure after the alteration designated by the frame state information in the currently valid frame structure information storage unit 15.

In addition, every time the update processing unit 14 updates the drawing information in the currently valid frame structure information storage unit 15, the drawing processing unit 16 writes the drawing contents the drawing information designates into the frame buffer 17, thereby executing the processing of displaying the drawing contents after the update on the screen in the process of drawing.

The display unit 18 is a display device such as an LCD or a monitor.

Incidentally, the drawing processing unit 16, frame buffer 17 and display unit 18 constitute a picture drawing device.

In the example of FIG. 1, although it is assumed that the components of the graphics data processing apparatus, that is, the touch panel 1, keyboard 2, buttons 3, input event reception unit 4, drawing event reception unit 5, event distributing unit 6, event queue 7, event acquiring unit 8, transition condition table 9, transition condition distributing unit 10, state transition processing unit 11, interframe transition table 12, frame transition processing unit 13, update processing unit 14, frame structure information storage unit 15, drawing processing unit 16, frame buffer 17 and display unit 18 are each comprised of dedicated hardware, the graphics data processing apparatus can be comprised of a computer.

When the graphics data processing apparatus is comprised of a computer, the event queue 7, transition condition table 9, interframe transition table 12, frame structure information storage unit 15 and frame buffer 17 are configured on an internal memory or external memory of the computer. In addition, programs describing the processing contents of the input event reception unit 4, drawing event reception unit 5, event distributing unit 6, event acquiring unit 8, transition condition distributing unit 10, state transition processing unit 11, frame transition processing unit 13, update processing unit 14 and drawing processing unit 16 are stored in the memory of the computer so that the CPU of the computer can execute the programs stored in the memory.

Next, the operation will be described.

FIG. 2 is a diagram illustrating a display example of the graphics data processing apparatus (display example of a needle meter).

The example of FIG. 2 shows the speedometer of a motorcar, and the following description will be made about the processing of updating the angle of the needle in the speedometer of FIG. 2 in real time.

It is assumed in the present embodiment 1 that the drawing event including the speed information of the motorcar is intermittently transmitted from an external sensor such as the speedometer of the motorcar, for example.

When the drawing event is transmitted from the external sensor, the drawing event reception unit 5 receives the drawing event, and supplies the drawing event to the event distributing unit 6.

The event distributing unit 6, receiving the drawing event from the drawing event reception unit 5, supplies the drawing event to the update processing unit 14.

In the present embodiment 1, to update the drawing contents of a picture in real time, the event distributing unit 6 distributes the drawing event supplied from the drawing event reception unit 5 to the update processing unit 14. However, if the event accepted by the drawing event reception unit 5 is not the drawing event, but a frame transition event, for example, it supplies the event to the event queue 7.

The update processing unit 14, receiving the drawing event from the event distributing unit 6, extracts the speed information of the motorcar from the drawing event.

The update processing unit 14, extracting the speed information of the motorcar, refers to the update table stored in the currently valid frame structure information storage unit 15 among the N frame structure information storage units 15 (the frame structure information storage unit 15 corresponding to the needle meter of FIG. 2), and specifies the angle information of the needle corresponding to the speed information.

For example, the update table stores the correspondence between the angle information of the needle in the speedometer and the speed information as shown below. Accordingly, if the speed of the motorcar is 40 km/h, for example, the angle of the needle is specified as 40 degrees.

| speed of motorcar | angle of needle | |
|---|---|---|
| 0 km/h | 0 | degree |
| 10 km/h | 10 | degrees |
| 20 km/h | 20 | degrees |
| 30 km/h | 30 | degrees |
| 40 km/h | 40 | degrees |
| 50 km/h | 50 | degrees |
| . | . | |
| . | . | |
| . | . | |
| 180 km/h | 180 | degrees |

Although the speed of the motorcar is related to the angle of the needle at every 10 km/h interval in the foregoing correspondence, it is only an example, and the speed of the motorcar can be related to the angle of the needle at every 1 km/h interval.

Although the example is shown in which the update processing unit 14 specifies the angle of the needle in the speedometer by referring to the update table, the angle of the needle in the speedometer can be specified by preparing an expression representing the correspondence between the angle information of the needle and the speed information, and by substituting the speed of the motorcar into the expression.

When the update processing unit 14 specifies the angle of the needle in the speedometer, it updates the drawing information by altering the rotational information of the component indicating the needle in the speedometer among the various components included in the drawing information in the currently valid frame structure information storage unit 15 (such as a component indicating the semicircular meter panel, and a component indicating the needle) in accordance with the angle specified.

The drawing processing unit 16 writes, every time the update processing unit 14 updates the drawing information in the currently valid frame structure information storage unit 15, the drawing contents the drawing information designates into the frame buffer 17, thereby displaying the drawing contents after the update on the screen in the process of drawing.

In this case, since it updates the rotational information of the component indicating the needle in the speedometer, it displays the needle in the speedometer at the angle the rotational information after the update indicates.

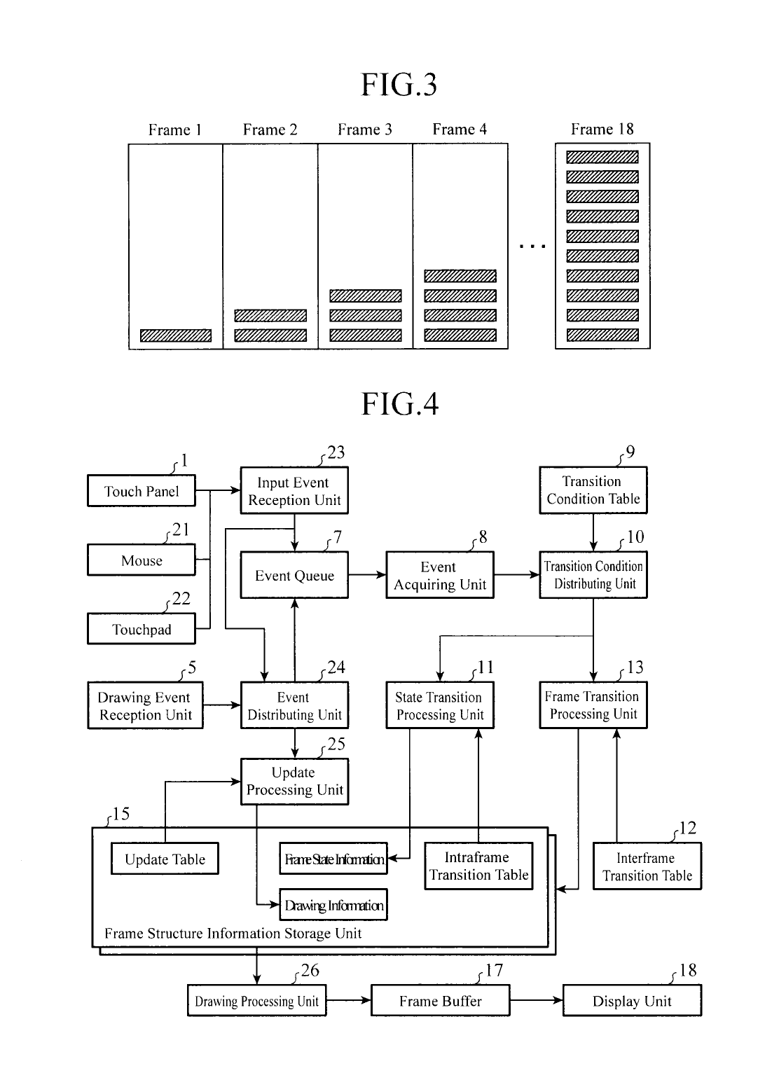

Next, the processing contents will be described which switch the display mode of the speedometer from the needle meter shown in FIG. 2 to a bar meter shown in FIG. 3.

The processing of switching the display mode of the speedometer is the processing of altering the frame structure performed under the operation of a user. However, since it does not generally require a real time operation such as the update of drawing contents based on a drawing event, a frame transition event (event instructing transition of the frame) or a coordinate input event (event designating intraframe coordinates) relating to the alteration processing is temporarily accumulated in the event queue 7.

More specifically, it is as follows.

A user inputs a frame transition event or a coordinate input event by operating the touch panel 1, keyboard 2, or buttons 3.

For convenience of explanation, it is assumed here that the user inputs the coordinate input event by operating the touch panel 1.

The input event reception unit 4 receives the coordinate input event input by operating the touch panel 1, and supplies the coordinate input event to the event queue 7.

This will cause the coordinate input event to be accumulated temporarily in the event queue 7.

The event acquiring unit 8 acquires an event accumulated in the event queue 7 in turn, and supplies the event to the transition condition distributing unit 10. It is assumed here that the coordinate input event is acquired.

Receiving the coordinate input event from the event acquiring unit 8, the transition condition distributing unit 10 refers to the transition condition information stored in the transition condition table 9, and decides on whether the coordinate input event instructs an intraframe transition or an interframe transition.

The transition condition table 9 stores, for example, the coordinates of the region on the touch panel 1 which accepts the intraframe transition and the coordinates of the region on the touch panel 1 which accepts the interframe transition. Accordingly, if the coordinates on the screen the coordinate input event designates are contained in the region that accepts the intraframe transition, the transition condition distributing unit 10 decides that the coordinate input event instructs the intraframe transition, and if the coordinates are contained in the region that accepts the interframe transition, it decides that the coordinate input event instructs the interframe transition.

The transition condition distributing unit 10 instructs, if the coordinate input event instructs the intraframe transition, the state transition processing unit 11 to execute the intraframe transition, and instructs if the coordinate input event instructs the interframe transition, the frame transition processing unit 13 to execute the interframe transition.

In the present embodiment 1, an example will be described which switches the display mode of the speedometer in accordance with the interframe transition.

Accordingly, it is assumed here that the transition condition distributing unit 10 identifies the interframe transition, and supplies the frame transition processing unit 13 with the instruction to execute the interframe transition.

However, it is only an example, and as for the processing of switching the display mode of the speedometer, it is also possible to switch the display mode of the speedometer by the intraframe transition.

Receiving the instruction to execute the interframe transition from the transition condition distributing unit 10, the frame transition processing unit 13 specifies the frame structure information storage unit 15 corresponding to the transition destination frame by referring to the interframe transition table 12.

Here, to switch the display mode of the speedometer from the needle meter shown in FIG. 2 to the bar meter shown in FIG. 3, the frame transition processing unit 13 specifies the frame structure information storage unit 15 corresponding to the bar meter of FIG. 3 from among the N frame structure information storage units 15.

When the frame transition processing unit 13 specifies the frame structure information storage unit 15 corresponding to the transition destination frame, it enables the frame structure information storage unit 15 and disables the other frame structure information storage units 15, thereby executing the interframe transition.

More specifically, it enables the frame structure information storage unit 15 corresponding to the bar meter of FIG. 3, and disables the other frame structure information storage units 15 including the frame structure information storage unit 15 corresponding to the needle meter of FIG. 2.

When the frame transition processing unit 13 changes the currently valid frame structure information storage unit 15, the drawing processing unit 16 writes the picture data (picture data for displaying the bar meter of FIG. 3) into the frame buffer 17 with the frame structure after the alteration the frame state information in the currently valid frame structure information storage unit 15 designates, thereby drawing the picture in the display unit 18.

After that, every time the drawing event including the speed information of the motorcar is transmitted intermittently from the external sensor such as the speedometer of the motorcar, the drawing event reception unit 5 receives the drawing event.

Receiving the drawing event from the event distributing unit 6, the update processing unit 14 extracts the speed information of the motorcar from the drawing event.

When the update processing unit 14 extracts the speed information of the motorcar, it refers to the update table stored in the currently valid frame structure information storage unit 15 (the frame structure information storage unit 15 corresponding to the bar meter of FIG. 3) among the N frame structure information storage units 15, and specifies the frame number corresponding to the speed information.

For example, the update table stores the correspondence between the frame number and the speed information as shown below. Thus, if the speed of the motorcar is 30 km/h, the frame number is identified as 3.

| speed of motorcar | frame number |
|---|---|
| 0 km/h | 0 |
| 10 km/h | 1 |
| 20 km/h | 2 |
| 30 km/h | 3 |
| 40 km/h | 4 |
| 50 km/h | 5 |
| . | . |
| . | . |
| . | . |
| 180 km/h | 18 |

Although the foregoing correspondence relates the speed of the motorcar to the frame number at 10 km/h intervals, it is only an example. The speed of the motorcar can also be related to the frame number at 1 km/h intervals.

After the update processing unit 14 identifies the frame number, it changes the components contained in the drawing information in the currently valid frame structure information storage unit 15 (the frame number of the components indicating the bar meter, for example) to the frame number identified.

Every time the update processing unit 14 updates the drawing information in the currently valid frame structure information storage unit 15, the drawing processing unit 16 writes the drawing contents the drawing information designates into the frame buffer 17, thereby displaying the drawing contents after the update on the screen in the process of drawing.

Here, since the frame number of the components indicating the bar meter is updated, the bar meter the frame number after the update designates is displayed.

For example, if the speed of the motorcar is 20 km/h, since the frame number is “2”, the bar meter with the frame number “2” is displayed, and if the speed of the motorcar 30 km/h, since the frame number is “3”, the bar meter with the frame number “3” is displayed.

As is clear from the above, according to the present embodiment 1, it is configured in such a manner as to comprise not only the input event reception unit 4 that receives the input such as a coordinate input event, and accumulates the coordinate input event or the like in the event queue 7; the event acquiring unit 8 that acquires the coordinate input event or the like accumulated in the event queue 7; and the event executing device that executes the coordinate input event or the like acquired by the event acquiring unit 8, but also the drawing event reception unit 5 that receives the drawing event designating the drawing contents of a picture; the update processing unit 14 that updates the drawing contents in accordance with the drawing event received by the drawing event reception unit 5; and the drawing processing unit 16 that displays the drawing contents on the screen every time the drawing contents are updated by the update processing unit 14. Accordingly, it offers an advantage of being able to update the drawing contents of the picture in real time, and to carry out the smooth drawing with jerks or the like being suppressed.

More specifically, the present embodiment 1 executes the processing of the drawing event designating the drawing contents of the picture without accumulating it in the event queue 7. Accordingly, it can update the drawing contents without being affected by the event queue accumulation, and hence can achieve the smooth drawing with jerks or the like being suppressed.

Although the present embodiment 1 shows an example in which the input event reception unit 4 receives the input of the coordinate input event, and accumulates the coordinate input event in the event queue 7, a configuration is also possible in which the input event reception unit 4 receives the input of a frame transition event instructing the transition of the frame, and accumulates the coordinate input event in the event queue 7.

In this case, the transition condition distributing unit 10 operates in such a manner that if the frame transition event acquired by the event acquiring unit 8 is an event relating to the intraframe transition, it instructs the state transition processing unit 11 to execute the intraframe transition, and if the frame transition event is an event relating to the interframe transition, it instructs the frame transition processing unit 13 to execute the interframe transition.

Although the present embodiment 1 shows an example in which when the frame transition processing unit 13 receives the instruction to execute the interframe transition from the transition condition distributing unit 10, it specifies the frame structure information storage unit 15 corresponding to the transition destination frame by referring to the interframe transition table 12, and executes the interframe transition by enabling the frame structure information storage unit 15 and by disabling the other frame structure information storage units 15, a configuration is also possible in which when the state transition processing unit 11 receives the instruction to execute the intraframe transition from the transition condition distributing unit 10, it can execute the intraframe transition by altering, in accordance with the instruction to execute the intraframe transition, the frame state information in the currently valid frame structure information storage unit 15 (corresponding to the information designating the frame structure of the drawing picture such as the information designating the state of the components displayed on the screen (information designating the visibility or invisibility), for example). It is conceivable as the intraframe transition, for example, the processing of displaying another picture designating a table or graph in a part of the screen.

### Embodiment 2

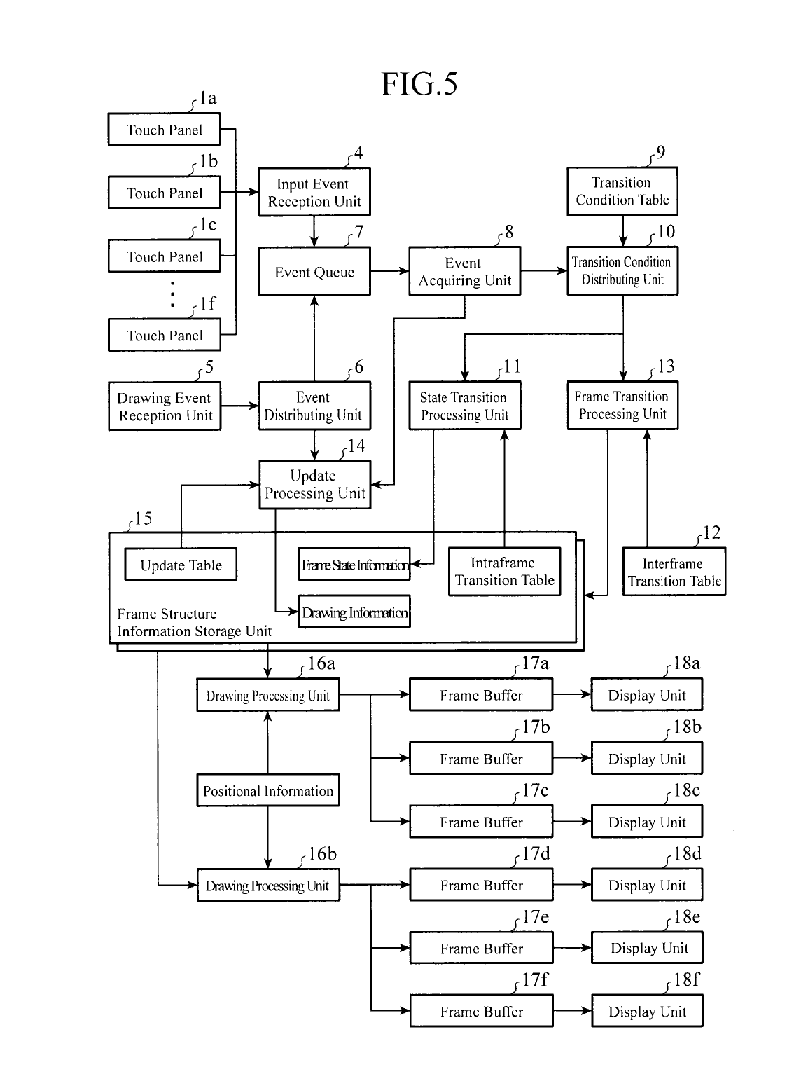

FIG. 4 is a block diagram showing a configuration of a graphics data processing apparatus of an embodiment 2 in accordance with the present invention. In FIG. 4, the same reference numerals as those of FIG. 1 designate the same or like components, and their description will be omitted.

A mouse 21 is a user interface a user can operate to input an event.

A touchpad 22 is a user interface a user can operate to input an event.

An input event reception unit 23, which is an interface for the touch panel 1, mouse 21 and touchpad 22, receives an event input by a user who operates the touch panel 1, mouse 21 and touchpad 22, and executes the processing of supplying the event to the event queue 7.

The input event reception unit 23, however, differs from the input event reception unit 4 of FIG. 1 in that as for a move event designating move information of a pointer input through the operation of the touch panel 1, mouse 21 or touchpad 22 (the move information of the mouse pointer, and the move information of the touchpad pointer, for example), it does not accumulate it in the event queue 7, but executes the processing of supplying it to an event distributing unit 24.

Incidentally, the touch panel 1, mouse 21, touchpad 22 and input event reception unit 23 constitute an event input device.

The event distributing unit 24, which is comprised of a semiconductor integrated circuit incorporating a CPU, or of a single-chip microcomputer, executes the processing of supplying, if the event accepted by the drawing event reception unit 5 is a drawing event, the event to an update processing unit 25, and of supplying, if the event accepted by the drawing event reception unit 5 is a frame transition event, the event to the event queue 7.

In addition, when the event distributing unit 24 receives a move event from the input event reception unit 23, it executes the processing of supplying the move event to the update processing unit 25.

The update processing unit 25, which is comprised of a semiconductor integrated circuit incorporating a CPU, or of a single-chip microcomputer, for example, executes, in the same manner as the update processing unit 14 of FIG. 1, the processing of altering the drawing information in the currently valid frame structure information storage unit 15 (that is, the information designating the drawing contents of a picture such as the positional information, rotational information, and the frame number of the components to be displayed on the screen) in accordance with the drawing event supplied from the event distributing unit 24.

In addition, the update processing unit 25, receiving the move event from the event distributing unit 24, outputs an instruction to move the pointer (mouse pointer, or touchpad pointer, for example) in accordance with the move event.

Incidentally, the update processing unit 25 constitutes a drawing content update device.

A drawing processing unit 26, which is comprised of a GPU (Graphics Processing Unit), for example, executes, when the state transition processing unit 11 alters the frame state information in the currently valid frame structure information storage unit 15, or when the frame transition processing unit 13 alters the currently valid frame structure information storage unit 15, the processing of drawing a picture on the display unit 18 by writing the data of the picture into the frame buffer 17 with the frame structure after the alteration designated by the frame state information in the currently valid frame structure information storage unit 15 in the same manner as the drawing processing unit 16 of FIG. 1.

In addition, every time the update processing unit 25 updates the drawing information in the currently valid frame structure information storage unit 15, the drawing processing unit 26 writes the drawing contents the drawing information designates into the frame buffer 17, thereby executing the processing of displaying the drawing contents after the update on the screen in the process of drawing in the same manner as the drawing processing unit 16 of FIG. 1.

The drawing processing unit 26 differs from the drawing processing unit 16 of FIG. 1 in that when it receives the move instruction of a pointer from the update processing unit 25, it executes the processing of altering the display position of the pointer in accordance with the move instruction.

Incidentally, the drawing processing unit 26, frame buffer 17 and display unit 18 constitute a picture drawing device.

In the example of FIG. 4, although it is assumed that the components of the graphics data processing apparatus, that is, the touch panel 1, mouse 21, touchpad 22, input event reception unit 23, drawing event reception unit 5, event distributing unit 24, event queue 7, event acquiring unit 8, transition condition table 9, transition condition distributing unit 10, state transition processing unit 11, interframe transition table 12, frame transition processing unit 13, update processing unit 25, frame structure information storage unit 15, drawing processing unit 26, frame buffer 17 and display unit 18 are each comprised of dedicated hardware, the graphics data processing apparatus can be comprised of a computer.

When the graphics data processing apparatus is comprised of a computer, the event queue 7, transition condition table 9, interframe transition table 12, frame structure information storage unit 15 and frame buffer 17 are configured on an internal memory or external memory of the computer. In addition, programs describing the processing contents of the input event reception unit 23, drawing event reception unit 5, event distributing unit 24, event acquiring unit 8, transition condition distributing unit 10, state transition processing unit 11, frame transition processing unit 13, update processing unit 25 and drawing processing unit 26 are stored in the memory of the computer so that the CPU of the computer can execute the programs stored in the memory.

Next the operation will be described.

Although the embodiment 1 shows the example which updates the drawing contents in real time without being affected by the event key accumulation and the like, a configuration is also possible which updates the display position of the mouse pointer or touchpad pointer in real time, for example.

More specifically, it is as follows.

Here, an example will be described in which a move event is input by a user who moves the mouse 21 or the like.

The input event reception unit 23 receives the event input through the operation of the touch panel 1, mouse 21 or touchpad 22 by the user, and supplies the event to the event queue 7.

Here, although the input event reception unit 23 accumulates the frame transition event and coordinate input event shown in the embodiment 1 in the event queue 7, it does not accumulate the move event designating the move information about the pointer input through the operation of the mouse 21 or the like in the event queue 7, but supplies it to the event distributing unit 24.

Receiving a move event from the input event reception unit 23, the event distributing unit 24 supplies the move event to the update processing unit 25.

Receiving the move event from the event distributing unit 24, the update processing unit 25 outputs an instruction to move the pointer (such as the mouse pointer and touchpad pointer) in accordance with the move event.

Receiving the move instruction of the pointer from the update processing unit 25, the drawing processing unit 26 alters the display position of the pointer in accordance with the move instruction.

As is clear from the above, according to the present embodiment 2, it is configured in such a manner that when receiving the input of a move event designating the move of the pointer through the mouse 21 or the like, it supplies the move event to the update processing unit 25 without accumulating it in the event queue 7, and that when the update processing unit 25 receives the move event, it outputs the instruction to move the pointer in accordance with the move event, and the drawing processing unit 26 alters the display position of the pointer in accordance with the move instruction supplied from the update processing unit 25. Accordingly, it offers an advantage of being able to update the display position of the pointer in real time without being affected by the event key accumulation.

### Embodiment 3

FIG. 5 is a block diagram showing a configuration of a graphics data processing apparatus of an embodiment 3 in accordance with the present invention. In FIG. 5, since the same reference numerals as those of FIG. 1 designate the same or like components, their description will be omitted.

Touch panels 1a, 1b, 1c, . . . , 1f are a user interface a user can operate to input an event, and constitute an event input device.

Incidentally, the touch panel 1a is mounted on a display unit 18a, the touch panel 1b is mounted on a display unit 18b, and the touch panel 1c is mounted on a display unit 18c.

In addition, the touch panel 1d is mounted on a display unit 18d, the touch panel 1e is mounted on a display unit 18e, and the touch panel 1f is mounted on a display unit 18f.

Drawing processing units 16a and 16b are each comprised of a GPU (Graphics Processing Unit), for example, and have the same functions as the drawing processing unit 16 of FIG. 1.

However, the drawing processing unit 16a corresponds to the display units 18a, 18b and 18c, and every time the update processing unit 14 updates the drawing information in the currently valid frame structure information storage unit 15, it writes the drawing contents the drawing information designates into frame buffers 17a, 17b and 17c, thereby executing the processing of displaying the drawing contents after the update on the screens of the display units 18a, 18b and 18c.

In addition, the drawing processing unit 16b corresponds to the display units 18d, 18e and 18f, and every time the update processing unit 14 updates the drawing information in the currently valid frame structure information storage unit 15, it writes the drawing contents the drawing information designates into frame buffers 17d, 17e and 17f, thereby executing the processing of displaying the drawing contents after the update on the screens of the display units 18d, 18e and 18f.

Incidentally, the drawing processing units 16a and 16b, the frame buffers 17a, 17b, 17c, 17d, 17e and 17f, and the display units 18a, 18b, 18c, 18d, 18e and 18f constitute a picture drawing device.

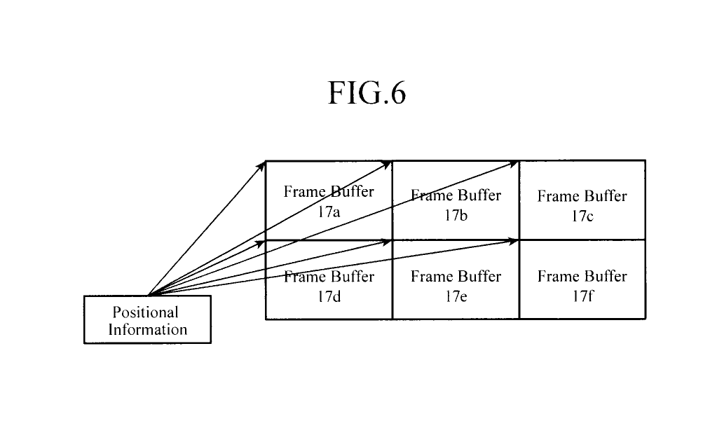

FIG. 6 is a diagram illustrating an example of a large screen that is comprised of the display units 18a, 18b, 18c, 18d, 18e and 18f.

In the foregoing embodiment 1, the drawing processing unit 16 corresponds to a single frame buffer 17 and display unit 18, and displays the drawing contents on the screen of the display unit 18 by writing the drawing contents the drawing information in the currently valid frame structure information storage unit 15 designates into the frame buffer 17. In the present embodiment 3, however, the drawing processing unit 16a corresponds to the three frame buffers 17a, 17b and 17c and display units 18a, 18b and 18c, and displays the drawing contents on the screens of the display units 18a, 18b and 18c by writing the drawing contents the drawing information in the frame structure information storage unit 15 corresponding to the display units 18a, 18b and 18c designates among the currently valid frame structure information storage unit 15 into the frame buffers 17a, 17b and 17c.

In addition, the drawing processing unit 16b corresponds to the three frame buffers 17d, 17e and 17f and display units 18d, 18e and 18f, and displays the drawing contents on the screens of the display units 18d, 18e and 18f by writing the drawing contents the drawing information in the frame structure information storage unit 15 corresponding to the display units 18d, 18e and 18f designates among the currently valid frame structure information storage unit 15 into the frame buffers 17d, 17e and 17f.

Incidentally, although the drawing processing itself of the drawing processing units 16a and 16b is basically the same as the drawing processing of the drawing processing unit 16 of FIG. 1, when the drawing processing units 16a and 16b writes the drawing contents into the frame buffers 17a-17f, they calculate the coordinate positions in the frame buffers into which they write the drawing contents from the positional information designating the upper left coordinates of the frame buffers 17a-17f, and write the drawing contents into the prescribed frame buffers.

In this way, even the large screen which is comprised of the plurality of display units 18a, 18b, 18c, 18d, 18e and 18f offers an advantage of being able to carryout the smooth drawing with jerks or the like being suppressed by updating the drawing contents of the picture in real time in the same manner as the embodiment 1.

Although the present embodiment 3 shows an example which is applied to the graphics data processing apparatus shown in the embodiment 1, it is also applicable to the graphics data processing apparatus shown in the embodiment 2.

### Embodiment 4

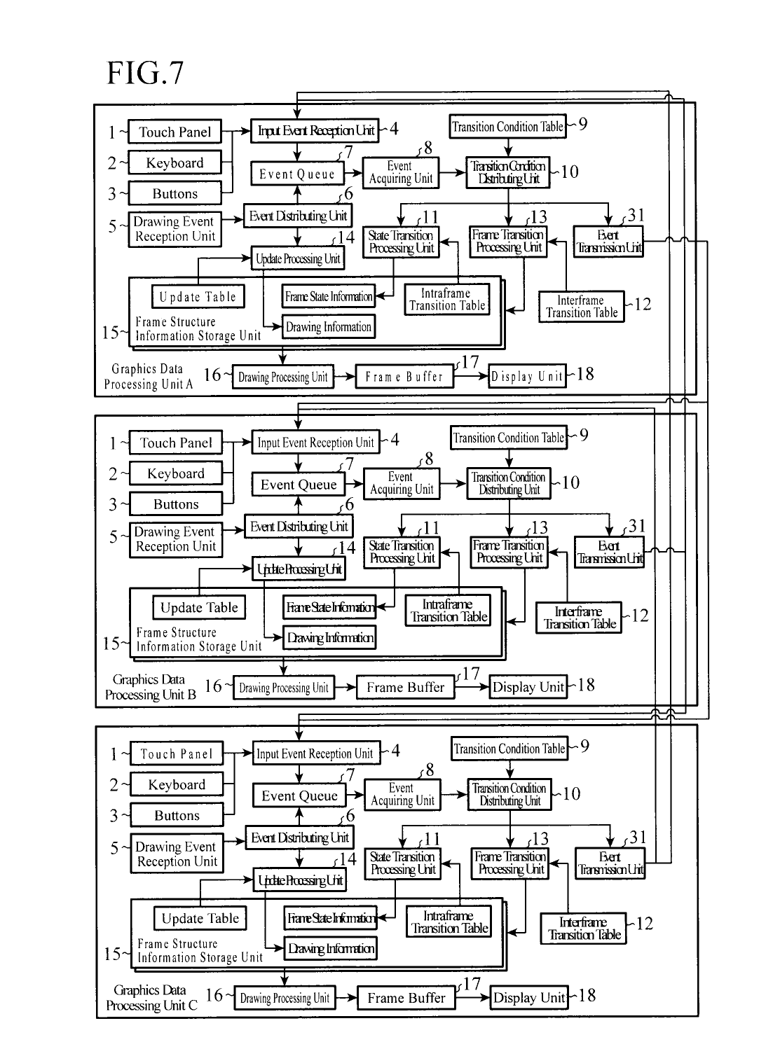

FIG. 7 is a block diagram showing a configuration of a graphics data processing system of an embodiment 4 in accordance with the present invention.

Although FIG. 7 shows a configuration comprising three graphics data processing apparatuses of the embodiment 1, the number of the graphics data processing apparatuses installed can be two or four or more.

In addition, a configuration is also possible which comprises a plurality of graphics data processing apparatuses of the embodiment 2 or 3.

An event transmission unit 31 of the graphics data processing apparatus A executes, if the transition condition distributing unit 10 thereof recognizes that the event acquired by the event acquiring unit 8 is not an event to the graphics data processing apparatus A (that is, an event to a graphics data processing apparatus B or C), the processing of distributing the event to the input event reception units 4 of the graphics data processing apparatuses B and C.

An event transmission unit 31 of the graphics data processing apparatus B executes, if the transition condition distributing unit 10 thereof recognizes that the event acquired by the event acquiring unit 8 is not an event to the graphics data processing apparatus B (that is, an event to a graphics data processing apparatus C or A), the processing of distributing the event to the input event reception units 4 of the graphics data processing apparatuses C and A.

An event transmission unit 31 of the graphics data processing apparatus C executes, if the transition condition distributing unit 10 thereof recognizes that the event acquired by the event acquiring unit 8 is not an event to the graphics data processing apparatus C (that is, an event to a graphics data processing apparatus A or B), the processing of distributing the event to the input event reception units 4 of the graphics data processing apparatuses A and B.

Incidentally, the event transmission units 31 constitute an event distribution device.

The present embodiment 4 comprises three graphics data processing apparatuses A, B and C. Here, if the event input to the graphics data processing apparatus A is an event to the graphics data processing apparatus B or C, the event transmission unit 31 of the graphics data processing apparatus A distributes the event to the input event reception units 4 of the graphics data processing apparatuses B and C.

In addition, if the event input to the graphics data processing apparatus B is an event to the graphics data processing apparatus C or A, the event transmission unit 31 of the graphics data processing apparatus B distributes the event to the input event reception units 4 of the graphics data processing apparatuses C and A.

In addition, if the event input to the graphics data processing apparatus C is an event to the graphics data processing apparatus A or B, the event transmission unit 31 of the graphics data processing apparatus C distributes the event to the input event reception units 4 of the graphics data processing apparatuses A and B.

This enables the graphics data processing apparatuses A, B and C to share the event input device such as the touch panel 1 and keyboard 2 with each other, which makes it possible to control the drawing of any desired graphics data processing apparatus by operating the touch panel 1 or the like of any one of the graphics data processing apparatuses.

In addition, in the same manner as the embodiments 1-3, the present embodiment 4 can achieve the smooth drawing with jerks or the like being suppressed by updating the drawing contents of the picture in real time.

### Embodiment 5

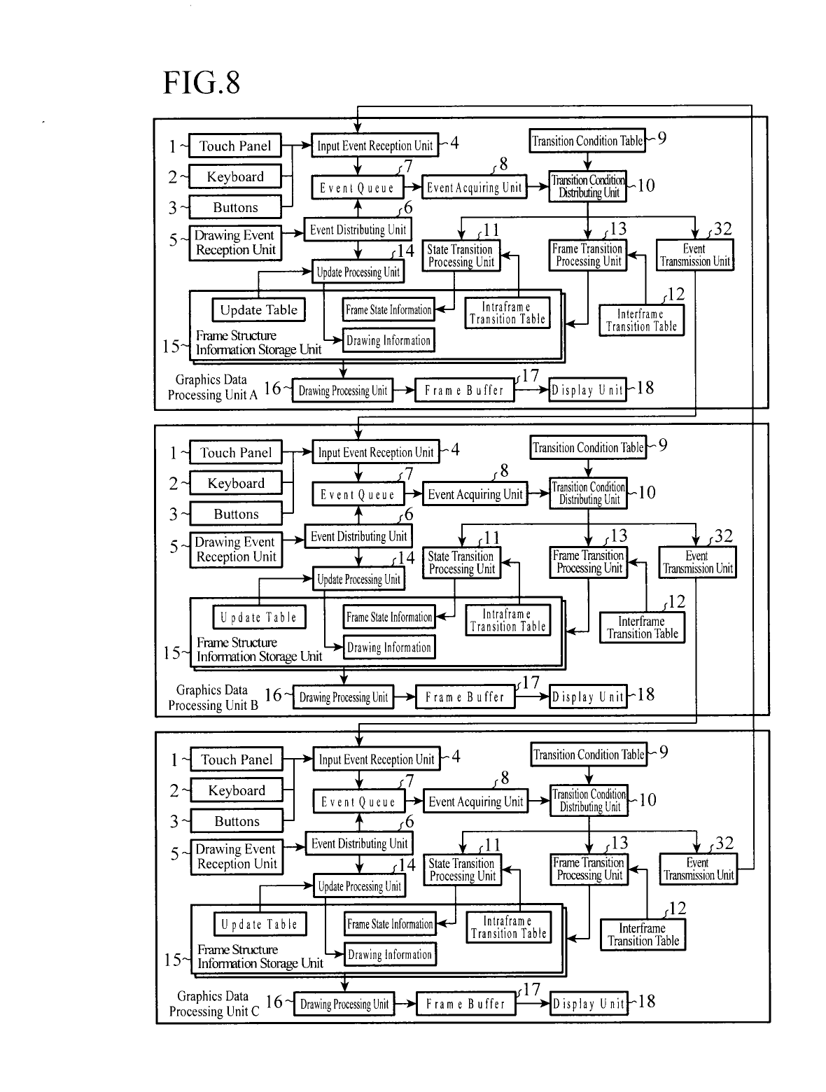

FIG. 8 is a block diagram showing a configuration of a graphics data processing system of an embodiment 5 in accordance with the present invention.

Although FIG. 8 shows a configuration comprising three graphics data processing apparatuses of the embodiment 1, the number of the graphics data processing apparatuses installed can be two or four or more.

In addition, a configuration is also possible which comprises a plurality of graphics data processing apparatuses of the embodiment 2 or 3.

An event transmission unit 32 of the graphics data processing apparatus A executes, if the transition condition distributing unit 10 thereof recognizes that the event acquired by the event acquiring unit 8 is not an event to the graphics data processing apparatus A (that is, an event to a graphics data processing apparatus B or C), the processing of distributing the event to the input event reception unit 4 of the graphics data processing apparatus B.

An event transmission unit 32 of the graphics data processing apparatus B executes, if the transition condition distributing unit 10 thereof recognizes that the event acquired by the event acquiring unit 8 is not an event to the graphics data processing apparatus B (that is, an event to a graphics data processing apparatus C or A), the processing of distributing the event to the input event reception unit 4 of the graphics data processing apparatus C.

An event transmission unit 32 of the graphics data processing apparatus C executes, if the transition condition distributing unit 10 thereof recognizes that the event acquired by the event acquiring unit 8 is not an event to the graphics data processing apparatus C (that is, an event to a graphics data processing apparatus A or B), the processing of distributing the event to the input event reception unit 4 of the graphics data processing apparatus A.

Incidentally, the event transmission units 32 constitute an event distribution device.

Although the foregoing embodiment 4 shows an example in which if the transition condition distributing unit 10 recognizes that the event acquired by the event acquiring unit 8 is not an event to its own graphics data processing apparatus, the event transmission unit 31 of the graphics data processing apparatus A, B or C transmits the event to the input event reception units 4 of the other graphics data processing apparatuses simultaneously, a configuration is also possible which transmits the event to the input event reception unit 4 of another graphics data processing apparatus in such a manner that the event circulates through the graphics data processing apparatuses A, B and C.

More specifically, if the event input to the graphics data processing apparatus A or the event transmitted from the graphics data processing apparatus C is not directed to the graphics data processing apparatus A, the event transmission unit 32 of the graphics data processing apparatus A distributes the event to the input event reception unit 4 of the graphics data processing apparatus B.

In addition, if the event input to the graphics data processing apparatus B or the event transmitted from the graphics data processing apparatus A is not directed to the graphics data processing apparatus B, the event transmission unit 32 of the graphics data processing apparatus B distributes the event to the input event reception unit 4 of the graphics data processing apparatus C.

Furthermore, if the event input to the graphics data processing apparatus C or the event transmitted from the graphics data processing apparatus B is not directed to the graphics data processing apparatus C, the event transmission unit 32 of the graphics data processing apparatus C distributes the event to the input event reception unit 4 of the graphics data processing apparatus A.

Incidentally, the event transmission units 32 of the graphics data processing apparatuses A, B and C can be configured in such a manner that when the event input to the graphics data processing apparatus A is not an event directed thereto, for example, they prevent forming such a loop that transmits the event from the graphics data processing apparatus A to the graphics data processing apparatus B, and to the graphics data processing apparatus C, and then returns the event to the graphics data processing apparatus A thereafter.

In the same manner as the embodiment 4, the present embodiment 5 can share the event input devices such as the touch panels 1 and keyboards 2 of the graphics data processing apparatuses A, B and C with each other. Accordingly, it can control the drawing of any desired graphics data processing apparatus by operating the touch panel 1 or the like of any one of the graphics data processing apparatuses.

In addition, in the same manner as the embodiments 1-3, the present embodiment 5 can achieve the smooth drawing with jerks or the like being suppressed by updating the drawing contents of the picture in real time.

Incidentally, it is to be understood that a free combination of the individual embodiments, variations of any components of the individual embodiments or removal of any components of the individual embodiments is possible within the scope of the present invention.

### INDUSTRIAL APPLICABILITY

A graphics data processing apparatus in accordance with the present invention is configured so as to carry out processing without accumulating a drawing event that designates drawing contents of a picture in an event queue, and to update the drawing contents without being affected by an event queue accumulation, thereby being able to realize smooth drawing with jerks or the like being suppressed. Accordingly, it is suitable for an application to a graphics data processing apparatus that draws a picture in real time.

### DESCRIPTION OF REFERENCE SYMBOLS

1, 1a-1f touch panel (event input device); 2 keyboard (event input device); 3 buttons (event input device); 4, 23 input event reception unit (event input device); 5 drawing event reception unit (drawing event reception device); 6 event distributing unit; 7 event queue; 8 event acquiring unit (event acquiring device); 9 transition condition table (event executing device); 10 transition condition distributing unit (event executing device); 11 state transition processing unit (event executing device); 12 interframe transition table (event executing device); 13 frame transition processing unit (event executing device); 14 update processing unit (drawing content update device); 15 frame structure information storage unit; 16, 16a, 16b drawing processing unit (picture drawing device); 17, 17a-17f frame buffer (picture drawing device); 18, 18a-18f display unit (picture drawing device); 21 mouse (event input device); 22 touchpad (event input device); 24 event distributing unit; 25 update processing unit (drawing content update device); 26 drawing processing unit (picture drawing device); 31, 32 event transmission unit (event distribution device).

What is claimed is:

1. A graphics data processing apparatus comprising:
an event input device that receives input of an event, and accumulates the event in an event queue;
an event acquiring device that acquires an event accumulated in the event queue;
an event executing device that executes the event acquired by the event acquiring device;
a drawing event reception device that receives a drawing event designating drawing contents of a screen;
a drawing content update device that updates drawing contents in accordance with the drawing event received by the drawing event reception device; and
a picture drawing device that displays, every time the drawing contents are updated by the drawing content update device, the drawing contents on the screen.

2. The graphics data processing apparatus according to claim 1, wherein
when the event whose input is received by the event input device is a frame transition event that instructs a transition of a frame, and when the frame transition event is acquired by the event acquiring device,
the event executing device alters a frame structure of a drawing picture in accordance with the frame transition event; and
the picture drawing device draws, when the event executing device alters the frame structure, a picture in accordance with the frame structure after the alteration.

3. The graphics data processing apparatus according to claim 1, wherein
when the event whose input is received by the event input device is a coordinate input event that designates coordinates in a screen, and when the coordinate input event is acquired by the event acquiring device,
the event executing device alters, when the coordinates designated by the coordinate input event are coordinates in a region instructing a transition of a frame, a frame structure of a drawing picture; and
the picture drawing device draws, when the event executing device alters the frame structure, a picture in accordance with the frame structure after the alteration.

4. The graphics data processing apparatus according to claim 1, wherein
the event input device, when receiving input of a move event designating a move of a pointer, does not accumulate the move event in the event queue, but supplies it to the drawing content update device;
the drawing content update device, receiving the move event from the event acquiring device, outputs an instruction to move the pointer in accordance with the move event; and
the picture drawing device alters the display position of the pointer in accordance with the move instruction output from the drawing content update device.

5. The graphics data processing apparatus according to claim 1, further comprising:
a plurality of picture drawing devices, wherein
the plurality of picture drawing devices draw pictures on corresponding display devices.

6. A graphics data processing system comprising a plurality of graphics data processing apparatuses of claim 1, wherein
the plurality of graphics data processing apparatuses each comprise an event distribution device that distributes, when the event acquired by the event acquiring device is not an event addressed to its own apparatus, the event to another graphics data processing apparatus.

7. The graphics data processing system according to claim 6, wherein
the event distribution device simultaneously transmits the event to the other graphics data processing apparatuses.

8. The graphics data processing system according to claim 6, wherein
the event distribution devices in the plurality of graphics data processing apparatuses transmit the event to another graphics data processing apparatus in a manner that the event circulates through the plurality of graphics data processing apparatuses.
